(19) United States
(12) Patent Application Publication
(10) Pub. No.: US 2008/0199764 A1
(43) Pub. Date: Aug. 21, 2008

(54) Safer high energy battery

(76) Inventors: Richard K. Holman, Belmont, MA (US); Andrew L. Loxley, Roslindale, MA (US)

Correspondence Address: WILMERHALE/BOSTON, 60 STATE STREET, BOSTON, MA, 02109, US

(21) Appl. No.: 11/408,500

(22) Filed: Apr. 20, 2006

Related U.S. Application Data
(60) Provisional application No. 60/673,404, filed on Apr. 20, 2005.

(51) Int. Cl. H01M 10/42; H01M 4/50; H01M 4/52; H01M 4/62; H01M 10/44

(52) U.S. Cl. 429/61; 429/162; 429/231.8; 429/231.3; 429/231.1; 429/224; 429/223; 429/217; 429/50

(57) ABSTRACT

A lithium secondary cell includes a plurality of stacked layers. Each stacked layer includes a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. The positive current collector is in electrical connection with an external circuit and has a total thickness of at least about 200 μm. The negative current collector is in electrical connection with an external circuit. The total cell polarization during a failure event reduces the rate of discharge such that catastrophic failure does not occur. Thus, the lithium secondary cell exhibits safer failure modes than conventional cells known in the art.

### BACKGROUND

1. Field of the Invention

This invention relates to a non-aqueous electrolyte secondary cell having high energy and capacity. In particular, the invention relates to a battery with high energy and capacity that does not fail catastrophically when overheated.

2. Background of the Invention

Contemporary portable electronic appliances rely predominantly on rechargeable Li-ion batteries as the source of power. This has spurred a continuing effort to increase their energy storage capability, power capabilities, cycle life and safety characteristics and decrease their cost. Lithium-ion battery or lithium ion cell refers to a rechargeable battery having an anode capable of storing a substantial amount of lithium at a lithium chemical potential above that of lithium metal.

Presently, a lithium ion secondary battery has been commercialized as a nonaqueous electrolyte secondary battery for use in wireless communication devices, such as a portable telephone. The lithium ion secondary battery includes a positive electrode containing lithium cobalt oxide (LCO), a negative electrode containing a graphitized material or a carbonaceous material, a nonaqueous electrolyte prepared by dissolving a lithium salt in an organic solvent, and a separator formed substantially of a porous film. A nonaqueous solvent having a low viscosity is used as the solvent for preparing the nonaqueous electrolyte.

Typical practice in the lithium ion battery field is to use electrodes having a thickness of 70 to 90 μm, a loading or capacity per unit area of 2.5 to 3.5 mAh/cm² (calendared to a density of 2.4-3.8 g/cm³ for the positive electrode based on LCO or 1.5-1.7 g/cm³ for the negative electrode based on graphite), and a microporous polyolefin separator having a thickness of 15 to 25 μm and a porosity of 35 to 40%. This leads typically to stack energy densities of 400 to 600 Wh/L and cell energy densities of 300 to 450 Wh/L.

For wound cells, the electrodes must also be capable of being wound to certain radii of curvature, which limits the thickness and density of the electrodes. For stacked cells, thicker electrodes have been avoided because of their reduced rate capability. Furthermore, safety concerns with high energy density cells, evidenced by numerous safety-related recalls of cell phone and laptop batteries, has taught away from the development of higher energy density cells based on LiCoO₂. See, http://www.cbsnews.com/stories/2004/10/28/tech/main652128.shtml (Exploding Cell Phones Spur Recalls). The slow adoption of the higher energy 2.4 Ah 18650 cylindrical cells (‘18’ denotes the diameter in millimeters and ‘650’ describes the length in millimeters) reflected the industry's concern with safety at higher energy density.

Practical Li-ion batteries used in consumer products such as cellular telephones and notebook computers are discharged at C/5 to 2 C rates and they are capable of 500-1000 full depth charge/discharge cycles. There is an ongoing effort to improve the specific energy, energy density and specific power (current drain rate) of Li-ion batteries.

### SUMMARY OF THE INVENTION

A thicker electrode, while theoretically providing high energy density, is typically a low rate electrode, and therefore not considered practical. Furthermore, higher energy density cells have been viewed by those skilled in the art as being less, not more, safe. The inventors have surprisingly and counter-intuitively discovered a lithium ion secondary battery incorporating one or more of the features of a high energy, low rate electrode, a low reactivity anode, and a non-bonded electrode stack configuration provides higher energy, yet greater safety.

According to one aspect of the invention, a lithium ion secondary battery includes a plurality of stacked layers. As used herein “stacked layers” refers to individual electrodes stacked one upon another to create multiple individual cells having a positive electrode, separator and negative electrode.

In one aspect of the invention, a lithium secondary cell includes a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. In this aspect, the positive current collector is in electrical connection with an external circuit. The positive electrode has a total thickness of at least about 200 μm. Also in this aspect, the negative current collector is in electrical connection with an external circuit. In this aspect, the total cell polarization during a failure event reduces the rate of discharge such that catastrophic failure does not occur. Nonlimiting examples of failure events include an internal shorting event, an external shorting event, a mechanical event, and a heat-related failure. Catastrophic failure is characterized by compromise of the external cell enclosure occurring either during a failure event or as a result of a failure event. Thus, in the cells of the invention the external cell enclosure is not compromised during a failure event.

In one aspect of the invention, a lithium secondary cell includes a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. In this aspect, the positive current collector is in electrical connection with an external circuit. The positive electrode has a total thickness of at least about 200 μm. Also in this aspect, the negative current collector is in electrical connection with an external circuit. The negative electrode comprises a carbonaceous material capable of reversibly intercalating lithium, an additive, and a binder. The binder is not reactive with the lithiated carbonaceous material at temperatures greater than about 200° C. In this aspect, the plurality of stacked layers is non-bonded.

In one aspect of the invention, a battery operable device includes a lithium secondary battery for generating power to the device. The lithium secondary battery is housed in a battery-operable device. The lithium secondary battery comprises a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. In this aspect, the positive current collector is in electrical connection with an external circuit. The positive electrode has a total thickness of at least about 200 μm. Also in this aspect, the negative current collector is in electrical connection with an external circuit. In this aspect, the total cell polarization during a failure event reduces the rate of discharge such that catastrophic failure does not occur.

In another aspect, the method includes a method of operating a lithium secondary battery. The method includes providing a lithium secondary battery and operating the lithium secondary battery such that the external cell enclosure is not compromised during a failure event. The lithium secondary battery of this aspect includes a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. In this aspect, the positive current collector is in electrical connection with an external circuit. The positive electrode has a total areal capacity of at least about 7.5 mA-h/cm² and a total thickness of at least about 200 μm. Also in this aspect, the negative current collector is in electrical connection with an external circuit.

In one aspect the stacked layer of the lithium ion secondary battery includes a lithium-containing positive electrode in electronic contact with a positive electrode current collector, the positive current collector in electrical connection with an external circuit, wherein the positive electrode has a total areal capacity of at least about 7.5 mA-h/cm², a thickness of at least about 95 μm for a single sided coated electrode excluding the current collector and a total thickness of at least about 200 μm for a double sided coated electrode including the current collector; a negative electrode in electronic contact with a negative electrode current collector, the negative current collector in electrical connection with an external circuit; a separator positioned between the cathode and the anode, the separator having a porosity of at least about 45 vol % and a thickness of less than about 50 μm; and an electrolyte in ionic contact with the positive and negative electrodes. The electrolyte has a conductivity of about 5-15×10⁻³ S and an electrolyte salt at a concentration in the range of about 0.5M to about 1.5 M.

Lithium secondary cells are provided having electrode stack energy densities exceeding about 200 Wh/Kg, and exceeding 600 Wh/L. For example, in one non-limiting embodiment, the stacked density is about 263 Wh/Kg. In another non-limiting embodiment the stacked density is about 726 Wh/L. In a prismatic form factor such as 63450 (where ‘6’ indicates a thickness of about 6 mm, ‘34’ indicates a width of 34 mm, and ‘50’ indicates a height of 50 mm), packaged cell energy densities exceeding 200 Wh/Kg (e.g., 213 Wh/Kg) and 500 Wh/L (e.g., 548 Wh/L) are provided.

### BRIEF DESCRIPTION OF THE DRAWING

A more complete appreciation of the present invention and many of its advantages will be understood by reference to the following detailed description when considered in connection with the following drawings, which are presented for the purpose of illustration only are not intended to limit the scope of the appended claims, and in which:

FIG. 1 is a schematic illustration of a lithium ion secondary cell having a stacked cell construction.

FIG. 2 is a comparative photograph of a lithium ion secondary cell of the current invention compared to a commercial cell after heating in an ARC chamber.

### DETAILED DESCRIPTION

Cells made according to one or more embodiments of the present invention have higher energy and are safer than state of the art prismatic cells. Without being bound by any particular scientific interpretation, the improved safety of the cell of the invention is believed to be due to one or more of the following factors: the nature of the stack separation during thermal events, the high electrode impedance under continuous discharge due to its thickness (areal loading and density), and the anode formulation. It is believed that selection of materials to optimize these factors results in an overall low discharge rate capability for the cell, thus effectively minimizing the occurrence of thermal runaway or other heat-generating failure.

The theory of high electrode impedance due to the cell's thickness is as follows. Because the electrodes of the present invention are at least about 50% thicker than state of the art prismatic cells (in some cases, greater than about 50% thicker), the total cell polarization is large when large discharge currents flow—such as would be observed if the cell fails due to a short-circuit. One skilled in the art will recognize that the impedance and voltage drop in this case is dominated by diffusion limitations within the pores of thick, dense electrodes, and that the effective impedance increase to first order is proportional to the square of the electrode thickness, other things being equal. Since heat is generated as a function of I²R (where I is current and R is resistance), and as current (I) is a function of V/R (where V is voltage), doubling the cell resistance under continuous discharge (such as occurs during a short circuit or other failure event) reduces the current by at least a factor of 2. Thus, the net result is half the total heat generated. Therefore, under failure by internal or external short-circuit, the short-circuit current is limited, causing the cell to fail in a less catastrophic fashion than standard cells.

The theory of stack separation is as follows. Because the electrode stack in the present invention is not bonded, if the cell short-circuits (or another heat generating failure event occurs), then the cell will quickly swell (e.g., due to gas generation) and the electrode stack will readily separate. The swelling and subsequent separation will cause an increase in the cell impedance (which will limit the short-circuit current). The layers will also thermally insulate themselves as they separate (one layer from the next), thereby reducing the tendency of neighboring layers to go into thermal runaway. It is also possible that separation of the layers disconnects the short circuit partially or entirely, reducing the current to a low value or even to zero.

The theory of improved safety via anode formulation is as follows. The anode used in the stacked assembly includes one or more components that are chemically stable in the presence of the lithiated carbon surface of the anode. For example, in one embodiment, the anode comprises a styrene-butadiene rubber (SBR) latex-based binder formulation. In more conventional formulations, the binder system is typically a fluorinated polymer, such as poly(vinylidene difluoride) (PVdF). At the elevated temperatures that are experienced within a cell during a failure event (e.g., greater than about 200° C.), it is well known that PVdF-based binding can react exothermically with the lithiated carbon surface (dehydrofluorination), contributing to thermal runaway. See, e.g., Du Pasquier, A, et al., J. Electrochem. Soc., 145 (2): 472-477 February 1998; Yang, H., et al., “Investigations of the Exothermic Reactions of Natural Graphite Anode for Li-Ion Batteries during Thermal Runaway”, J. Electrochem. Soc, 152: A73-A79 (2005); Wang Q., et al., “Thermal Behavior of Lithiated Graphite with Electrolyte in Lithium-Ion Batteries,” J. Electrochem. Soc., 153(2): A329-A333 (2006). Thus, during a failure event (e.g., an internal or external short), the reaction between the PVdF and the lithiated carbon surface will evolve additional heat, raising the cell temperature and contributing to the thermal runaway. In comparison, because the anode components of the invention are less reactive to the lithiated carbon surface of the anode, during a failure event, they do not interact with the carbon surface in the same way, generating less heat that contributes to the failure of the device.

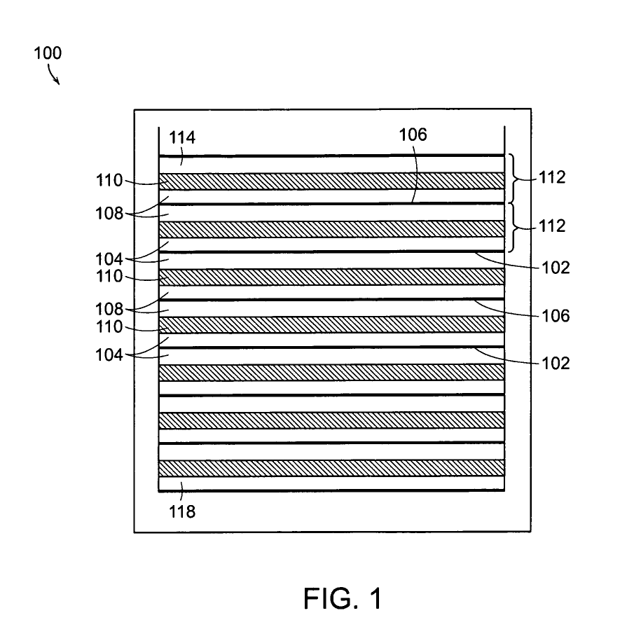

FIG. 1 is an illustration of a typical stacked cell construction 100. The stacked cell construction includes a positive current collector 102 coated on two sides with a cathode mixture 104 and a negative current collector 106 coated on two sides with an anode mixture 108. Interposed between each double-sided electrode is a separator 110. The repeated arrangement of positive electrode/separator/negative electrode forms multiple individual cells 112 bounded by a positive current collector and a negative current collector. Single-sided electrodes 114, 118 on the outer two faces of the stacked assembly complete the stacked cell construction. The single-sided electrodes are bounded by a positive or negative current collector as appropriate for the electrode. These current collectors at the outer faces of the stacked assembly are coated on one side as shown in FIG. 1. The entire stacked assembly is infused with electrolyte (not shown). The use of stacked layers permits use of thicker electrodes to obtain higher energy and capacity without the limits due to radius of curvature found in wound cells. In a typical stacked cell 22 individual stacked cells 112 are included in a single battery. In some embodiments, about 2-32 individual stacked cells 112 are included in a single battery. In other embodiments, about 5-25 individual stacked cells 112 are included in a single battery. In further embodiments, about 15-25 individual stacked cells 112 are included in a single battery. In some embodiments, about 18 individual stacked cells 112 are included in a single battery. In other embodiments, about 20 individual stacked cells 112 are included in a single battery. In further embodiments, about 24 individual stacked cells 112 are included in a single battery. In some embodiments, about 32 individual stacked cells 112 are included in a single battery.

As used herein ‘electrode thickness’ refers to the thickness of a single layer of electrode excluding the current collector, and ‘total thickness’ refers to the thickness of the double layer electrode including the current collector. A real capacity, volumetric specific capacity and total volumetric energy density are reported for the thickness of the double layer electrode including the current collector.

Battery failure is characterized by overheating of the cell during a heat-generating failure event, such as short-circuiting (either internal or external), exposure to excessive heat, or mechanical failure. In some embodiments, battery failure results in the external cell or battery enclosure (e.g., the metal can or ends of the battery) being compromised. Examples of such catastrophic failure modes include, without limitation, breach, bending, and disintegration.

In the present invention, the individual stacked cells are un-bonded. In stacked cells of the prior art, bonding typically occurs between the separator surface and the neighboring electrode surfaces, either through an adhesive or by treating the separator with a solvent, polymer or polymer/solvent solution to achieve a surface that bonds to the electrodes. For example, if the separator is treated with a solvent that is compatible with the electrode binder, the binder will soften and essentially act as an adhesive between the separator and the electrode. Referring to FIG. 1, the interface between separator 110 and electrodes 108 and 104 is a non-bonding interface. For example, there are no components between the separator or the electrode surface (i.e., no adhesives or solvents are used in the making of the non-bonded stacks). Similarly, the interface between separator 110 and 114 or 118 is a non-bonding interface.

The positive electrode includes a cathode active material and a binder. In some embodiments, the positive electrode also contains a conductive additive. The cathode active material can be chosen from a number of candidates (subject to the restrictions outlined herein), including but not limited to lithium metal oxide. Nonlimiting examples of lithium metal oxides include lithium cobalt oxide, lithium nickel cobalt oxide, lithium nickel manganese cobalt oxide, lithium manganese oxide, or mixtures of two or more of these materials.

Similarly, the negative electrode includes an anode active material and a binder. In some embodiments, the negative electrode also contains a conductive additive. In some embodiments, the anode active material is a carbonaceous material capable of reversibly intercalating lithium. For example, the anode active material can be chosen from a number of candidates (subject to the restrictions outlined above), including but not limited to synthetic graphite, natural graphite, mesocarbon microbeads (MCMB), and coke. Other anode active materials include, without limitation, metal and metal alloy anode materials (e.g. Sn), metalloid anode materials (e.g. Si), and intermetallic compound anode materials.

The conductive additive includes, for example, acetylene black, carbon black and graphite.

The binder can perform the functions of allowing the current collector to hold the active material and of joining the active material particles. Exemplary materials used as the binder include, for example, polytetrafluoro ethylene (PTFE), polyvinylidene fluoride (PVdF), an ethylene-propylene-diene copolymer (EPDM), styrene-butadiene rubber (SBR), polystyrene, polyethylene and polypropylene. In some embodiments, polyethylene and polypropylene are used as dry binders (i.e., the electrodes are formed by pressing, rather than by formation of a slurry and subsequent drying). In some embodiments, the binder also includes carboxymethylcellulose. In some embodiments, the binder includes a blend of SBR and carboxymethylcellulose. In some embodiments, the binder is not reactive with the carbonaceous anode active material, when the anode material is intercalated with lithium (i.e., when the material is a lithiated carbonaceous material. Examples of such non-reactive binder materials include, without limitation, styrene-butadiene rubber (SBR), polystyrene, polyethylene and polypropylene. In some embodiments, the non-reactive binder material is not a fluorinated polymer (e.g., PVdF and PTFE).

Exemplary positive electrode compositions include between 92 and 99% by weight of cathode active material, a range of about 0.5% and 4% by weight of conductive diluent, and a range of between 0.5% and 4% by weight binder. The positive electrode is deposited on both sides of a current collector at a total thickness of greater than about 200 μm. In some embodiments, the positive electrode has a total thickness of greater than about 230 μm. In some embodiments, the positive electrode has a total thickness of greater than about 250 μm. In other embodiments, the positive electrode has a total thickness of about 200 μm to about 250 μm. The current collector is a thin metal foil, typically aluminum, or some other conductive material stable at the maximum positive electrode potential.

In some embodiments, the positive electrode has a total areal capacity of greater than about 7.5 mA-h/cm². In some embodiments, the positive electrode has a total areal capacity of greater than about 7.7 mA-h/cm². In other embodiments, the positive electrode has a total areal capacity of greater than about 8.0 mA-h/cm². In further embodiments, the positive electrode has a total areal capacity of greater than about 9.0 mA-h/cm². In some embodiments, the positive electrode has a total areal capacity of greater than about 10.0 mA-h/cm². In yet more embodiments, the positive electrode has a total areal capacity of about 7.5 mA-h/cm² to about 10.0 mA-h/cm². In some embodiments, the positive electrode has a total areal capacity of about 7.5 mA-h/cm² to about 11.0 mA-h/cm². Areal capacities are reversible capacities and are determined against a graphite anode.

Another way to describe the energy characteristics of the positive electrode is by its volumetric specific capacity (i.e., the total amount of electrical charge the cathode is able to hold per unit volume). In some embodiments, the positive electrode has a volumetric specific capacity of at least about 350 Ah/L. In some embodiments, the positive electrode has a volumetric specific capacity of at least about 375 Ah/L. In some embodiments, the positive electrode has a volumetric specific capacity of at least about 400 Ah/L. In some embodiments, the positive electrode has a volumetric specific capacity of at least about 425 Ah/L. In other embodiments, the positive electrode has a volumetric specific capacity of at least about 445 Ah/L. In further embodiments, the positive electrode has a volumetric specific capacity of at least about 475 Ah/L. In yet more embodiments, the positive electrode has a volumetric specific capacity of at least about 500 Ah/L.

Exemplary negative electrode compositions include between 92 and 99% by weight of cathode active material, a range of about 0% and 3% by weight of conductive diluent, and a range of between about 1% and about 5% by weight binder. The negative electrode is deposited on both sides of a current collector, unless the electrode is located at the end of the stacked cell, in which case only one side is coated. The total thickness of the negative electrode will vary depending on the nature of the negative electrode active material, e.g., carbon or metal, but it is at a load level that provides an energy capacity matching or exceeding the capacity of the positive electrode.

A cell made from lithium cobalt oxide positive electrode and graphite negative electrode meeting the above criteria can be made using the following range of compositions.
Positive electrode: 92-99 w % LCO; 0.5-4 w % carbon black; and 0.5-4 w % PVdF binder at a total thickness of greater than 200 μm.
Negative electrode: 94-99 w % graphite; 0-3 w % carbon black; and 1-3 w % SBR latex-carboxymethylcellulose (CMC) blend, in ratios of SBR:CMC of 1:4 to 100% SBR latex, or 2-6 w % PVdF-based binder at a total thickness of greater than 150 μm.

The separator is formed essentially of a porous sheet. The porous sheet used as the separator includes, for example, a porous film and an unwoven fabric. It is desirable for the porous sheet to contain at least one material selected from the group consisting of polyolefin and cellulose. The polyolefin noted above includes, for example, polyethylene and polypropylene. Particularly, in some embodiments, a porous film containing polyethylene or both polyethylene and polypropylene is used as the separator because the particular separator permits improving the safety of the secondary battery. In these embodiments, as the cell temperature rises, the separator pores will close, thereby increasing the resistance of the separator. One method of characterizing the porosity of the separator is by Gurley number, where a lower Gurley numbers correspond to increased porosity. In some embodiments the Gurley number (JIS standard) of the separator is <300. In other embodiments, the Gurley number of the separator is <250. In further embodiments, the Gurley number of the separator is <200. In some embodiments, the Gurley number of the separator is <150.

In one or more embodiments, the thickness of the porous sheet is less than 50 μm, or in the range of about 10 μm to 30 μm. The separator has a porosity of greater than about 45%, or greater than about 50%.

In one or more embodiments, the separator has a low degree of shrinkage in the cross-web (sideways) direction at elevated temperatures (e.g., greater than about 100° C.). In the stacked cell construction, the cross-web direction is the direction that tends to expose the electrode surfaces to shorting. In some embodiments, the degree of separator shrinkage is less than about 3% at 108° C. In some embodiments, the degree of separator shrinkage is less than about 10% at 120° C.

A stacked assembly is made by alternately stacking anode and cathode layers meeting the above criteria with high porosity separator layers that electrically isolate the anode and cathode layers, either manually or by employing an automated stacking machine. The stacked cell construction is activated with one of a family of liquid electrolytes suitable for Li-ion cells. The electrolyte may be infused into a porous separator that electronically isolates the positive and negative electrodes.

Numerous organic solvents have been proposed as the components of Li-ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li-ion battery electrolyte solutions include γ-BL, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate and the like. These nonaqueous solvents are typically used as multicomponent mixtures.

A solid or gel electrolyte may also be employed. The electrolyte may be an inorganic solid electrolyte, e.g., Li₃N or LiI, or a high molecular weight solid electrolyte, such as a gel, provided that the material exhibits lithium conductivity. Exemplary high molecular weight compounds include poly(ethylene oxide), poly(methacrylate) ester based compounds, or an acrylate-based polymer, and the like.

As the lithium salt, at least one compound from among LiClO₄, LiPF₆, LiBF₄, LiSO₃CF₃, LiN(SO₂CF₃)₂, LiN(SO₂CF₂CF₃)₂ and the like are used. The lithium salt is at a concentration from 0.5 to 1.5 M, or about 1.3 M. In one or more embodiments, the lithium salt is used as a concentration of greater than 1.0 M. Typically the electrolyte is a solution of mixed carbonate solvents with a Li salt (e.g. LiPF₆) dissolved as the charge carrying species.

Further, although the above description uses an example of a liquid type nonaqueous electrolyte Li-ion battery, it is to be understood that other types of non-aqueous electrolytes, such as those of gel or solid polymer type can be used to manufacture thin batteries of this invention, whose electrodes may be bonded to their respective separators and packaged in thin metal-polymer laminate film bags as an outer casing material.

The electrode, separator and electrolyte combination is surrounded by an external cell or battery enclosure, e.g., a metal can.

A high energy lithium ion secondary cell operating at a minimum of 1.25 Ah includes a high energy density positive electrode with a total electrode volumetric energy density of at least 1460 Wh/L as measured versus Li metal at C/5 rate. This corresponds to electrode active loadings of at least 59 mg/cm² for a two sided electrode in a system having a total electrode plus current collector foil thickness of 230 μm. The cell also includes a high energy density negative electrode with a volumetric specific capacity including current collector foil of at least 460 Ah/L. This corresponds to electrode active loadings of at least 23 mg/cm² (per side of a doubly coated current collector) in a graphite system having a total electrode plus current collector foil thickness of 184 μm. The porous separator material is 10-30 μm thick and has a porosity greater than 45 vol %.

In some embodiments, the positive electrode has a total volumetric energy density (i.e., the amount of electrical energy stored in the electrode per unit volume) of at least about 1460 Wh/L versus lithium at C/5 rate. In other embodiments, the positive electrode has a total volumetric energy density of at least about 1480 Wh/L versus lithium at C/5 rate. In further embodiments, the positive electrode has a total volumetric energy density of at least about 1500 Wh/L versus lithium at C/5 rate. In yet other embodiments, the positive electrode has a total volumetric energy density of at least about 1520 Wh/L versus lithium at C/5 rate. In other embodiments, the positive electrode has a total volumetric energy density of at least about 1540 Wh/L versus lithium at C/5 rate. In some embodiments, the positive electrode has a total volumetric energy density of at least about 1600 Wh/L versus lithium at C/5 rate. In some embodiments, the positive electrode has a total volumetric energy density of at least about 1650 Wh/L versus lithium at C/5 rate. In some embodiments, the positive electrode has a total volumetric energy density of at least about 1750 Wh/L versus lithium at C/5 rate. In some embodiments, the positive electrode has a total volumetric energy density of at least about 1460 Wh/L to about 1540 Wh/L versus lithium at C/5 rate. In some embodiments, the positive electrode has a total volumetric energy density of at least about 1460 Wh/L to about 1750 Wh/L versus lithium at C/5 rate.

In some embodiments, the negative electrode has a total volumetric specific capacity of at least about 460 Ah/L. In some embodiments, the negative electrode has a total volumetric specific capacity of at least about 483 Ah/L. In other embodiments; the negative electrode has a total volumetric specific capacity of at least about 510 Ah/L. In some embodiments, the negative electrode has a total volumetric specific capacity of at least about 525 Ah/L. In other embodiments, the negative electrode has a total volumetric specific capacity of at least about 555 Ah/L. In further embodiments, the negative electrode has a total volumetric specific capacity of at least about 460 Ah/L to about 555 Ah/L. In some embodiments, the negative electrode has a total volumetric specific capacity of at least about 460 Ah/L to about 510 Ah/L. In further embodiments, the negative electrode has a total volumetric specific capacity including current collector foil of at least about 460 Ah/L to about 483 Ah/L. In some embodiments, the negative electrode has a total volumetric specific capacity of at least about 460 Ah/L to about 525 Ah/L. In further embodiments, the negative electrode has a total volumetric specific capacity of at least about 460 Ah/L to about 515 Ah/L.

In some embodiments, the stack energy density of the cell is at least about 650 Wh/L. In further embodiments, the stack energy density of the cell is at least about 675 Wh/L. In yet more embodiments, the stack energy density of the cell is at least about 700 Wh/L.

Cells of the present invention are used in a variety of applications. The cells may be used in both pulsed protocols and continuous discharge protocols. In some embodiments, the cell is incorporated into a portable electronic device. In some embodiments, the cell is incorporated into a wireless communication device. In one embodiment, the device is a cellular telephone. In another embodiment, the device is a two-way pager. In some embodiments, the cells of the present invention are used in personal stereo equipment, including but not limited to MP3 players. In other cells, the batteries of the invention are used in medical devices, including but not limited to defibrillators.

The invention is illustrated in the following examples, which are presented for the purpose of illustration only and are not intended to be limiting of the invention.

### EXAMPLE 1

Cells made according to one or more embodiments of the present invention have higher energy and are safer than state of the art prismatic cells as demonstrated by the results of accelerated rate calorimetry; a fully charged, state of the art commercially available 63046 1 Ah prismatic cell was heated at 2° C./min in an ARC chamber. At 130° C. the temperature of the cell rose sharply as the LCO cathode material went into the well known thermal runaway. The cell bulged excessively and eventually exploded violently and burst open to eject the electrodes from within the metal can (and presumably metal shrapnel from the can itself). Such violent eruption on thermal runaway is clearly an undesired feature of a telecommunications battery pack cell that may be held close to the head during device usage.

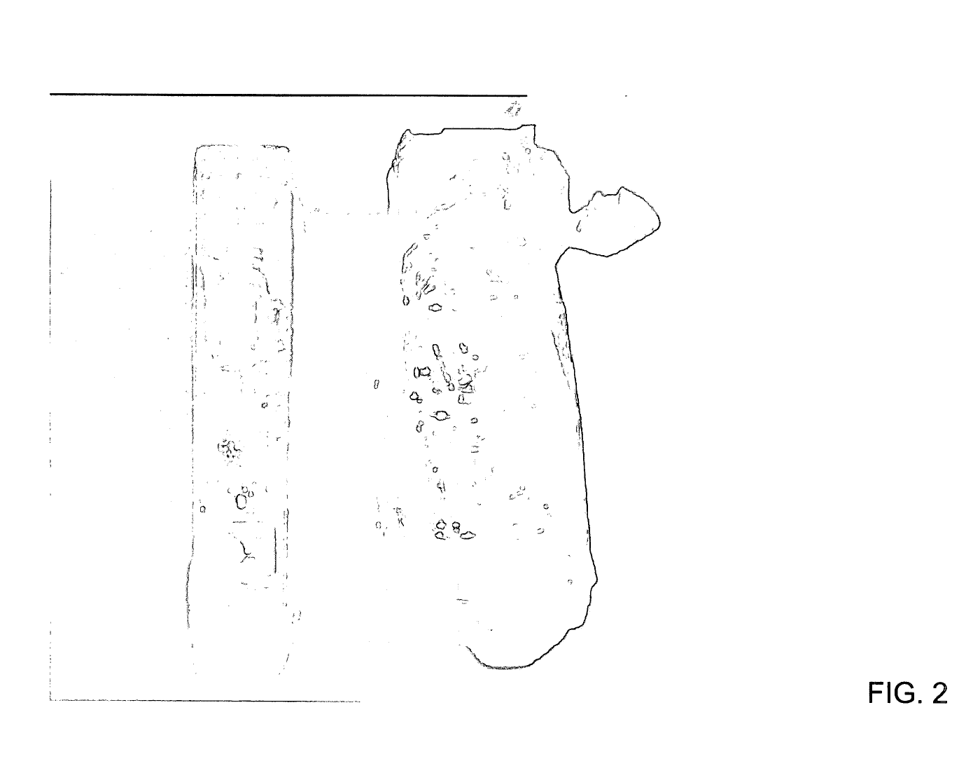

In contrast, when cells made according to the present invention go into the thermal runaway (also at 130° C. and with the same self-heating rate as the comparison cell), the failure is very mild, there is no can bulging or explosion, and the cell contents remain inside the cell. The results are illustrated in FIG. 2. The commercial cell on the right shows complete breach of the cell canister, and a cell made according to the present invention on the left remains intact. No smoking or evidence of explosion was observed.

What is claimed is:

1. A lithium secondary cell, comprising:
an external cell enclosure;
a plurality of stacked layers, said stacked layer comprising:
a lithium-containing positive electrode in electronic contact with a positive electrode current collector, the positive current collector in electrical connection with an external circuit wherein the positive electrode has a total thickness of at least about 200 μm;
a negative electrode in electronic contact with a negative electrode current collector, the negative current collector in electrical connection with an external circuit;
a separator positioned between the positive electrode and the negative electrode; and
an electrolyte in ionic contact with the positive and negative electrodes
wherein the total cell polarization during a failure event reduces the rate of discharge such that catastrophic failure does not occur.

2. The lithium secondary cell of claim 1, wherein the failure event is selected from the following: an internal shorting event, an external shorting event, a mechanical event, and a heat-related failure.

3. The lithium secondary cell of claim 1, wherein during the catastrophic failure the external cell enclosure is compromised.

4. The lithium secondary cell of claim 1, wherein the positive electrode has a total areal capacity of at least about 7.5 mA-h/cm² and a total thickness of at least about 200 μm.

5. The lithium secondary cell of claim 2, wherein the positive electrode has a total areal capacity of at least about 7.5 mA-h/cm² and a total thickness of at least about 230 μm.

6. The lithium secondary cell of claim 2, wherein the positive electrode has a total areal capacity of at least about 8.0 mA-h/cm².

7. The lithium secondary cell of claim 2, wherein the positive electrode has a total areal capacity of at least about 9.0 mA-h/cm².

8. The lithium secondary cell of claim 1, wherein the positive electrode has a total volumetric energy density of at least about 1460 Wh/L versus lithium at C/5 rate.

9. The lithium secondary cell of claim 1, wherein the positive electrode has a total volumetric energy density of at least about 1500 Wh/L versus lithium at C/5 rate.

10. The lithium secondary cell of claim 1, wherein the positive electrode has a total volumetric energy density of at least about 1540 Wh/L versus lithium at C/5 rate.

11. The lithium secondary cell of claim 1, wherein the positive electrode has a volumetric specific capacity of at least about 350 Ah/L.

12. The lithium secondary cell of claim 1, wherein the stack energy density of the cell is at least about 675 Ah/L.

13. The lithium secondary cell of claim 1, wherein the plurality of stacked layers is non-bonded.

14. The lithium secondary cell of claim 1, wherein the positive electrode comprises an active material selected from the group consisting of lithium cobalt oxide, lithium nickel cobalt oxide, lithium nickel manganese cobalt oxide, lithium manganese oxide, and mixtures thereof.

15. The lithium secondary cell of claim 1, wherein the positive electrode comprises lithium cobalt oxide.

16. The lithium secondary cell of claim 1, wherein the negative electrode comprises an active material selected from the group consisting of synthetic graphite, natural graphite, mesocarbon microbeads (MCMB), coke, metal and metal alloy anode materials, metalloid anode materials, and intermetallic compound anode materials.

17. The lithium secondary cell of claim 1, wherein the negative electrode comprises a carbonaceous material capable of reversibly intercalating lithium.

18. The lithium secondary cell of claim 17, wherein the negative electrode further comprises a binder, wherein the binder is not reactive with the lithiated carbonaceous material at temperatures greater than about 200° C.

19. The lithium secondary cell of claim 18, wherein the binder does not comprise a fluorinated polymer.

20. The lithium secondary cell of claim 18, wherein the binder comprises styrene-butadiene rubber.

21. A lithium secondary cell, comprising:
a plurality of stacked layers, said stacked layer comprising:
a lithium-containing positive electrode in electronic contact with a positive electrode current collector, the positive current collector in electrical connection with an external circuit, wherein the total thickness of the positive electrode is at least about 200 μm;
a negative electrode in electronic contact with a negative electrode current collector, the negative current collector in electrical connection with an external circuit, wherein the negative electrode comprises a carbonaceous active material capable of reversibly intercalating lithium, an additive, and a binder, and wherein the binder is not reactive with the lithiated carbonaceous active material at temperatures greater than about 200° C.;
a separator positioned between the positive electrode and the negative electrode, and
an electrolyte in ionic contact with the positive and negative electrodes, wherein
the plurality of stacked layers is non-bonded.

22. The lithium secondary cell of claim 21, wherein the binder does not comprise a fluorinated polymer.

23. The lithium secondary cell of claim 21, wherein the binder comprises styrene-butadiene rubber.

24. The lithium secondary cell of claim 21, wherein the positive electrode has a total areal capacity of at least about 7.5 mA-h/cm² and a total thickness of at least about 200 μm

25. The lithium secondary cell of claim 21, wherein the separator has a porosity of at least about 45 vol % and a thickness of less than about 50 μm.

26. The lithium secondary cell of claim 21, wherein the conductivity of the electrolyte is about 5-15×10⁻³ S and the electrolyte concentration is about 0.5M to about 1.5M.

27. The lithium secondary cell of claim 21, wherein the positive electrode has a total volumetric energy density of at least about 1460 Wh/L versus lithium at C/5 rate.

28. The lithium secondary cell of claim 21, wherein the positive electrode has a volumetric specific capacity of at least about 350 Ah/L.

29. The lithium secondary cell of claim 21, wherein the stack energy density of the cell is at least about 675 Ah/L.

30. A battery operable device, comprising:
a lithium secondary battery for generating power to the device, the lithium secondary battery housed in a battery-operable device, wherein the lithium secondary battery comprises:
an external cell enclosure,
a lithium-containing positive electrode in electronic contact with a positive electrode current collector, the positive current collector in electrical connection with an external circuit, wherein the positive electrode has a total thickness of at least about 200 μm;
a negative electrode in electronic contact with a negative electrode current collector, the negative current collector in electrical connection with an external circuit;
a separator positioned between the positive electrode and the negative electrode; and
an electrolyte in ionic contact with the positive and negative electrodes,
wherein the total cell polarization during a failure event reduces the rate of discharge such that catastrophic failure does not occur.

31. The portable electronic device of claim 30, wherein the failure event is selected from the following: an internal shorting event, an external shorting event, a mechanical event, and a heat-related failure.

32. The portable electronic device of claim 30, wherein during the catastrophic failure the external cell enclosure is compromised.

33. The portable electronic device of claim 30, wherein the positive electrode has a total areal capacity of greater than about 7.5 mA-h/cm² and a total thickness of at least about 200 μm.

34. The portable electronic device of claim 33, wherein the positive electrode has a total areal capacity of greater than about 8.0 mA-h/cm².

35. The portable electronic device of claim 33, wherein the positive electrode has a total areal capacity of greater than about 9.0 mA-h/cm².

36. The portable electronic device of claim 30, wherein the positive electrode has a total volumetric energy density of at least about 1460 Wh/L versus lithium at C/5 rate.

37. The lithium secondary cell of claim 30, wherein the positive electrode has a volumetric specific capacity of at least about 350 Ah/L.

38. The lithium secondary cell of claim 30, wherein the stack energy density of the cell is at least about 675 Ah/L.

39. The portable electronic device of claim 30, wherein the plurality of stacked layers is non-bonded.

40. The portable electronic device of claim 30, wherein the negative electrode comprises a carbonaceous material capable of reversibly intercalating lithium.

41. The lithium secondary cell of claim 40, wherein the negative electrode further comprises a binder, wherein the binder is not reactive with the lithiated carbonaceous material at temperatures greater than about 200° C.

42. The lithium secondary cell of claim 41, wherein the binder does not comprise a fluorinated polymer.

43. The portable electronic device of claim 41, wherein the binder comprises styrene-butadiene rubber.

44. A method of operating a lithium secondary battery, comprising:
providing a lithium secondary battery, wherein the lithium secondary battery comprises:
an external cell enclosure;
a plurality of stacked layers, said stacked layer comprising:
a lithium-containing positive electrode in electronic contact with a positive electrode current collector, the positive current collector in electrical connection with an external circuit, wherein the positive electrode has a total areal capacity of at least about 7.5 mA-h/cm² and a total thickness of at least about 200 μm;
a negative electrode in electronic contact with a negative electrode current collector, the negative current collector in electrical connection with an external circuit; and
operating the lithium secondary battery such that the external cell enclosure is not compromised during a failure event.

45. The method of claim 44, wherein the positive electrode has a total areal capacity of at least about 7.5 mA-h/cm² and a total thickness of at least about 230 μm.

46. The method of claim 45, wherein the positive electrode has a total areal capacity of at least about 8.0 mA-h/cm².

47. The method of claim 45, wherein the positive electrode has a total areal capacity of at least about 9.0 mA-h/cm².

48. The method of claim 44, wherein the positive electrode has a total volumetric energy density of at least about 1460 Wh/L versus lithium at C/5 rate.

49. The lithium secondary cell of claim 44, wherein the positive electrode has a volumetric specific capacity of at least about 350 Ah/L.

50. The lithium secondary cell of claim 44, wherein the stack energy density of the cell is at least about 675 Ah/L.

51. The method of claim 44, wherein the plurality of stacked layers are non-bonded.

52. The method of claim 44, wherein the negative electrode comprises a carbonaceous material capable of reversibly intercalating lithium.

53. The lithium secondary cell of claim 52, wherein the negative electrode further comprises a binder, wherein the binder is not reactive with the lithiated carbonaceous material at temperatures greater than about 200° C.

54. The lithium secondary cell of claim 53, wherein the binder does not comprise a fluorinated polymer.

55. The method of claim 53, wherein the binder comprises styrene-butadiene rubber.
